(19) United States
(12) Patent Application Publication
(10) Pub. No.: US 2008/0004092 A1
(43) Pub. Date: Jan. 3, 2008

(54) Remote sieve or chaffer adjustment

(75) Inventors: Frederick William Nelson, Waukee, IA (US); Bruce Alan Coers, Hillsdale, IL (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/479,005

(22) Filed: Jun. 30, 2006

(51) Int. Cl. A01F 12/32

(52) U.S. Cl. 460/101

(57) ABSTRACT

An adjustment mechanism for an oscillating sieve or chaffer comprises a first member that extends from the sieve or chaffer and a selective engagement device that selectively engages the first member and uses the difference in velocity between the two—the oscillating movement of the sieve or chaffer—to adjust louvers of the sieve or chaffer.

### FIELD OF THE INVENTION

The invention relates to agricultural harvesters. More particularly, it relates to cleaning devices for harvesters. Even more particularly, it relates to sieves and chaffers for harvesters.

### BACKGROUND OF THE INVENTION

Harvesters not only cut and thresh grain, they also separate and clean it. Sieves and chaffers are used to clean grain in the final stage of harvesting. A fan directs a flow of air backward and upward through the sieve and chaffer, lifting the lighter chaff and straw and carrying it backward out the rear of the harvester. The heavier grain is not levitated by the grain, but falls downward through the sieve and chaffer and into a grain auger for conveying into a grain tank.

The performance of the sieve and chaffer is a function of the shape of the openings in the sieve and chaffer though which the air passes and the speed of the fan. Both of these control the velocity of the air as it passes through the sieve and chaffer and hence the levitating power of the sieve and chaffer. Too much lift and grain is carried to the rear of the harvester and dumped on the ground with the chaff. Too little lift and the chaff falls through air passages in the sieve and chaffer and is sent to the grain tank.

The sieve and chaffer are supported on a frame, that in turn is supported on pivoting arm. These arms, permit the sieve and chaffer to shake back and forth (i.e. fore-and-aft) between the outer sidewalls of the harvester to help separate the chaff from the grain.

The sieves and chaffers are adjustable to control the air speed therethrough and the rate at which the chaff and grain are moved backward toward the rear of the harvester. Typical adjustable chaffers and sieves are shown, for example, in U.S. Pat. No. 6,632,136 which issued to Deere & Company. In this arrangement, a linkage driven by a motor adjusts the elements of the chaffer and sieve. One problem with this arrangement is the accelerated wear of the motor and its wiring harness. The sieve and chaffer oscillate fore and aft a distance of 50 or 60 mm at 300 oscillations per minute. Over time, this vibration can damage the sieve and chaffer adjustment devices.

What is needed therefore is an adjustment mechanism that is stationary and does not oscillate with the sieve and chaffer. What is also needed is an adjustment mechanism that uses the oscillation of the sieve and chaffer to adjust the sieve and chaffer.

It is an object of this invention to provide such an adjustment mechanism.

### SUMMARY OF THE INVENTION

In accordance with a first aspect of the invention, a sieve or chaffer adjustment mechanism includes a first member extending from the sieve or chaffer which engages a selective engagement device that uses the oscillation of the sieve or chaffer with respect to the harvester vehicle to adjust the louvers of the sieve or chaffer.

In accordance with a second aspect of the invention, a method of adjusting a sieve or chaffer having a first member extending therefrom by coupling a selective engagement device to the first member and employing the oscillating motion of the sieve or chaffer to adjust the louvers of the sieve or chaffer.

### BRIEF DESCRIPTION OF THE DRAWINGS

FIG. 1 is a side view of an agricultural harvester showing the sieve or chaffer in phantom lines and the sieve and chaffer adjustment mechanism fixed to the sidewall of the harvester.

FIG. 2 is a perspective side view of the harvester of FIG. 1 with the sidewall of the harvester and other components removed to show the sieve, chaffer, and sieve and chaffer adjustment mechanism.

FIG. 3 is a fragmentary view of the sidewall of the harvester of FIGS. 1 and 2 showing details of the sieve and chaffer adjustment mechanism.

### DESCRIPTION OF THE PREFERRED EMBODIMENT

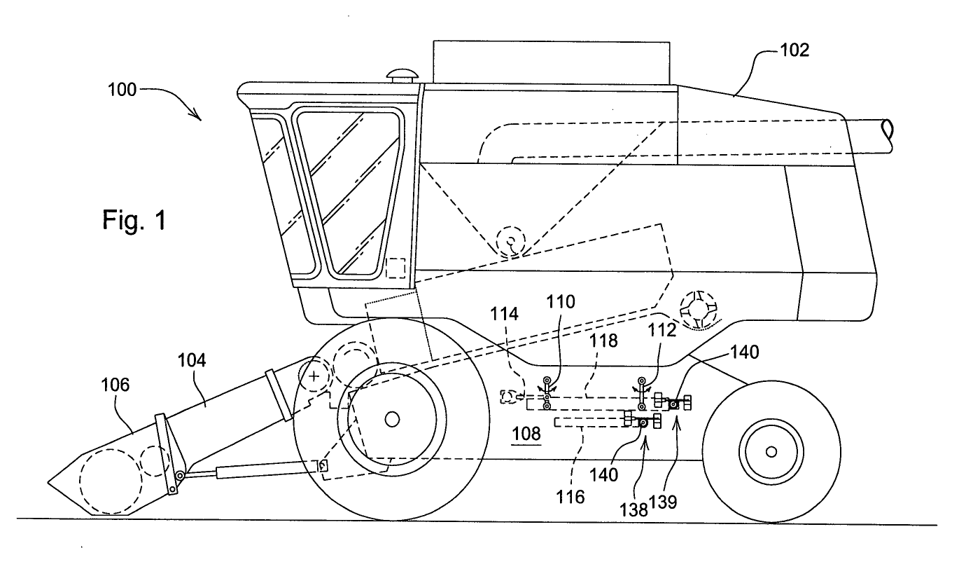

Referring now to FIG. 1, an agricultural harvester 100 is shown, comprising self propelled vehicle portion 102 to which a feeder house 104 is pivotally coupled. The feeder house 104 supports a header 106 which is configured to gather and cut the crop. The feeder house 104 receives material from the header 106 and conveys it to the vehicle portion 102 for threshing, separation, cleaning, and storage.

A sidewall 108 of the vehicle 102 supports two hangers 110, 112 that support the front and rear end of a grain shoe 115. Two identically disposed hangers 120, 122 are located on the other side of the vehicle to support the other side of the grain shoe 115. A connecting rod 114 is pivotally coupled to the lower end of hanger 110 to oscillate the hanger and hence the grain shoe which is supported on the end of hanger 110 back and forth. The lower ends of the hangers extend through the left and right sidewalls (right sidewall not shown) of the vehicle and engage the grain shoe 115 which is disposed inside the vehicle between the two sidewalls.

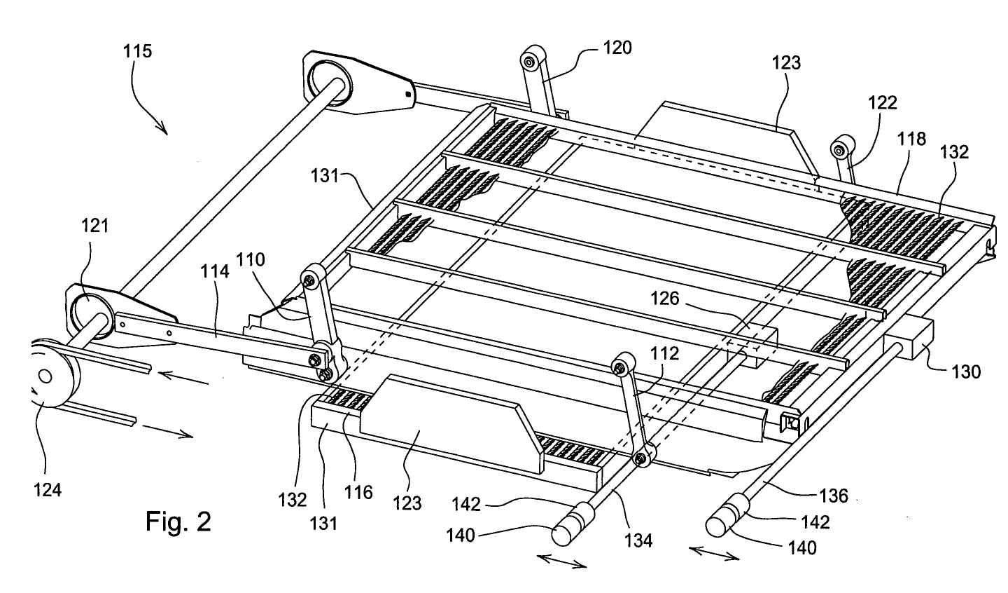

Referring to FIG. 2, grain shoe 115 is disposed within and supported by the harvester and comprises a sieve 116 and a chaffer 118 that are supported on left side hangers 110, 112 and right side hangers 120, 122. The sieve and chaffer are fixed together by frame portions 123 fixed to the left and right sides of the sieve and chaffer.

The sieve and chaffer are driven by a connecting rod 114 that is coupled to hanger 110 on one end and to the eccentric mounting point on an eccentric disk 121 at the other end. The eccentric disk is driven by a pulley 124. As the pulley rotates, its motion is turned into reciprocating motion by the connecting rod, causing the grain shoe, sieve, and chaffer to oscillate back and forth with respect to the frame of the harvester, which also means with respect to the sidewall of the harvester, since the sidewall of the harvester is fixed with respect to the harvester frame or chassis.

The speed of oscillation is about 300 oscillations per minute, and the amplitude is through an arc of about 50 or 60 mm.

Each of the sieve and chaffer comprise a frame 131 that supports a plurality of laterally extending louvers 132. A right angle gearbox 126 is mounted on the sieve and an identical right angle gearbox 130 is mounted on the chaffer to convert the rotary motion of shafts 134, 136 into rotary motion about axes that are parallel to the plane of the sieve and chaffer, respectively, and extend generally longitudinally in the direction of the vehicle's travel. These gearboxes are coupled to the louvers 132 of the sieve and chaffer, respectively, to adjust the angle of the louvers 132 with respect to the frame 131 and control the flow of air therethrough.

The mechanism for adjusting the louvers and for coupling the gearbox to the louvers is described in greater detail in U.S. Pat. No. 6,632,136, which issued to Deere & Company and is incorporated herein by reference for all that it teaches.

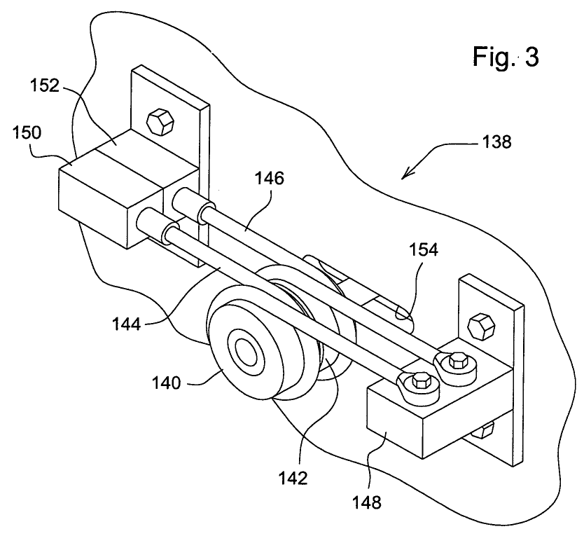

In the present invention, the gearbox replaces the motor 66 of the '136 patent. The louver adjustment mechanism shown in the '136 patent is the same in both. The gearboxes 126 and 130 are coupled to laterally extending shafts 134 and 136, respectively, such that rotation of the shafts serves the same louver adjusting functions that rotation of the motors does in the '136 patent. Shafts 134 and 136 extend slightly through the left sidewall of the harvester, as shown in FIG. 3, where each is connected to sieve and chaffer adjustment mechanisms 138, 139.

FIG. 3 illustrates only one of these adjustment mechanisms (i.e. sieve adjustment mechanism 138) for convenience, since mechanisms 138, 139 are identical in construction and operation.

Referring now to FIGS. 1 and 3, a sieve adjustment mechanism 138 is coupled to the end of shaft 134. This mechanism includes two overrunning clutches 140, 142, bands 144, 146 wrapped around the circumference of respective overrunning clutches 140, 142, an anchor 148 coupled to one end of both bands and to the left sidewall of the harvester, and two tensioners 150, 152 coupled to the other end of the bands 144,146. The sieve adjustment mechanism is a device that selectively engages to the first member to convert the motion of the first member with respect to the sieve adjustment mechanism into an adjustment of the louvers. the force used to adjust the louvers comes from the motion of the sieve and chaffer with respect to the sieve adjustment device, or more generally the motion of the sieve and chaffer with respect to the frame of the harvester.

This difference in velocity is generated by the pulley, eccentric disk and connecting rod, which, when driven by the harvester's engine, cause the sieve and chaffer to oscillate with respect to the frame of the harvester.

An aperture 154 is provided in the sidewall of the harvester through which shaft 134 extends.

The anchor 148 is fixed to the sidewall of the harvester adjacent to one end of the aperture 154, and the tensioners are fixed to the sidewall adjacent to the other end of the aperture 154.

Due to the motion of the sieve and chaffer, shaft 134 oscillates back and forth in aperture 154 between the tensioners and the anchor. As long as the tensioners are not engaged, there is sufficient slack in the bands to permit the overrunning clutches 140, 142 to move back and forth without binding against the band and rotating about the axis of shaft 134. When either tensioner is engaged, however, the band associated with that tensioner is tightened and the band binds against (e.g. engages with) the circumferential surface of the overrunning clutch. When this happens, the clutch, located in a now-tight loop of band, rolls or rotates back and forth along the band as it oscillates back and forth with respect to the vehicle. The clutches are overrunning clutches because they can spin freely with respect to shaft 134 in one rotational direction, but bind against the shaft and rotate only with the shaft when rotated in the other direction.

The outboard clutch 140, when rotated back and forth as the sieve and chaffer oscillate fore and aft, only drives shaft 134 in rotation when clutch 140 is rotated clockwise by band 144, and thus can only rotate shaft 134 in a clockwise direction.

The inboard clutch 142 is oriented just the opposite. When rotated back and forth as the sieve and chaffer oscillate fore and aft, it only drives shaft 134 in rotation when clutch 142 is rotated counter-clockwise by band 146, and thus can only rotate shaft 134 in a counter-clockwise direction.

In this manner the shafts can be gradually rotated clockwise by energizing outboard tensioner 150 and gradually rotated counter-clockwise by energizing inboard tensioner 152.

The two clutches convert the linear motion of the sieve with respect to the frame and sidewall of the harvester into rotary motion of the overrunning clutch, which in turn converts the bidirectional rotary motion into unidirectional rotary motion of the shaft 134, which in turn adjusts the louvers. The direction of that unidirectional motion (CW or CCW rotation) depends upon which tensioner is energized.

As a point of similarity, ratchet wrenches convert bidirectional rotary motion into unidirectional rotary motion in the same manner.

Having described the preferred embodiment, it will become apparent that various modifications can be made without departing from the scope of the invention as defined in the accompanying claims. For example, rather than tightening a belt, the overrunning clutches could be fitted with gear teeth on their periphery and a toothed rack could be lowered (preferably by a device like the solenoid tensioner) into engagement with the teeth of the overrunning clutch to generate the reversing rotational movement of the overrunning clutch. With gear teeth the rack would rotate the clutches in both directions and the clutch would translate this bidirectional rotation into unidirectional rotation of the shaft.

In another embodiment, the rack can provide the clutch action (and the clutches can be disposed of by replacing the clutches with a knob having a saw-tooth periphery and the rack provided with mating saw teeth. The rack can be spring-loaded against the saw-toothed knob such that the rack will only rotate the knob when moved in one direction and will not engage the saw teeth of the knob when drawn in the other direction.

In this manner, two adjacent racks with saw teeth facing in opposite directions that engage two saw-toothed knobs on the shaft will permit the shaft to be ratcheted and unidirectionally rotated in a first direction by one saw-tooth knob and rack pair and ratcheted and unidirectionally rotated in the opposite direction by the other saw-tooth rack and knob pair.

Alternatively, the overrunning clutches could be replaced with simple knobs fixed to their shafts and a tensioner can selectively tighten the band during the forward movement of the sieve and chaffer, then release the band during the backward movement of the sieve and chaffer in this manner the band will stepwise rotate the knob clockwise only. The tensioner could similarly tighten the band only when the sieve and chaffer are moving backward to stepwise rotate the knob counter-clockwise. This would permit the elimination of the overrunning clutch and replace the clutching action with the once-an-oscillation tightening and loosening of the band. Similarly, rather than intermittently tightening a band, the band could be replaced with the toothed rack (described above) and rather than intermittently tightening the band, the rack could be intermittently lowered into engagement with a toothed outer surface of the knob to rotate the knob (and its shaft) clockwise or counter-clockwise in the same manner as the band. In another alternative arrangement, several independently adjustable chaffer and sieve sections may be provided in place of the single chaffer and sieve sections illustrated herein, each section being equipped with its own gearbox, shaft and adjustment mechanism. In all these embodiments, the adjusting mechanism and selective engagement devices are coupled to and stationary with respect to the frame and sidewall of the agricultural harvester. Only the shaft and knob or unidirectional clutches move with respect to the frame and sidewall of the vehicle. in yet another alternative configuration, the sieve and chaffer can be separately supported for independent oscillation, each being supported on its own set of hangers, and can either be driven by a common driver (such as pulley 124 and eccentric disk 123) or can be driven by a separate and independent driver. In yet another alternative configuration, one or both of the adjusters can be disposed on the right side of the harvester, with a shaft extending through the right sidewall of the harvester.

1. A remote adjuster for remotely adjusting a sieve or chaffer supported for oscillation in an agricultural harvester, said sieve or chaffer comprising a sieve or chaffer frame and louvers supported by the frame, wherein the adjusting comprises changing the orientation of the louvers with respect to the sieve or chaffer frame, wherein said sieve or chaffer is configured to oscillate with respect to the harvester to separate crop from chaff, the adjuster comprising:
a first member coupled to the louvers and adjustable to vary the orientation of the louvers with respect to one another; and
a selective engagement device attached to a non-oscillating portion of the harvester and configured to adjust the member thereby varying the orientation of the louvers by employing the oscillation to adjust the first member.

2. The remote adjuster of claim 1, wherein the remote adjuster is powered by the sieve or chaffer drive mechanism.

3. The remote adjuster of claim 1, wherein the selective engagement device includes an overrunning clutch that is configured to convert the oscillating movement of the sieve or chaffer into rotation of the first member to thereby adjust the chaffer.

4. The remote adjuster of claim 1, wherein the first member comprises a shaft rotatable to adjust the sieve or chaffer and further wherein the selective engagement device converts the oscillation into intermittent rotary motion of the shaft.

5. A method of remotely adjusting the louvers of a sieve or chaffer supported for oscillation in an agricultural harvester, said sieve or chaffer comprising a sieve or chaffer frame and louvers supported by the frame, wherein the adjusting comprises changing the orientation of the louvers with respect to the sieve or chaffer frame, wherein said sieve or chaffer is configured to oscillate with respect to the harvester to separate crop from chaff, the method comprising:
providing a first member coupled to the louvers and adjustable to vary the orientation of the louvers with respect to one another;
providing a selective engagement device that is stationary with respect to the harvester frame;
coupling the selective engagement device to the first member; and while so coupled
employing the oscillation to adjust the first member.

6. The method of claim 5, wherein the oscillations are generated by a sieve or chaffer drive mechanism.

7. The method of claim 5, wherein the step of coupling includes the step of engaging an overrunning clutch to drive the first member.

8. The method of claim 5, wherein the step of employing the oscillation to adjust the first member includes the step of adjusting the louvers with the first member.

9. The method of claim 8, wherein the first member is a shaft rotatable to adjust the sieve or chaffer and further wherein the step of adjusting includes the step of converting reciprocating movement of the sieve or chaffer with respect to the frame of the harvester into rotary motion of the first member.
